(19) United States
(12) Patent Application Publication
(10) Pub. No.: US 2013/0092698 A1
(43) Pub. Date: Apr. 18, 2013

(54) Container for removing liquid from a cleaning head

(71) Applicant: Vittorio Orlandi, Arsago Seprio (IT)

(72) Inventor: Vittorio Orlandi, Arsago Seprio (IT)

(73) Assignee: ORLANDI S.P.A., Cassano Magnago (IT)

(21) Appl. No.: 13/507,130

(22) Filed: Jun. 6, 2012

(30) Foreign Application Priority Data
Oct. 18, 2011 (IT) MI2011U000331

(51) Int. Cl. B65D 8/04; B29C 45/00

(52) U.S. Cl. 220/660; 264/328.1

(57) ABSTRACT

A container and method for making a container for removing liquid from a cleaning head includes a base wall and a lateral wall peripherally extending from a first side of the base wall. The base wall further includes on the first side, a protruding portion adapted to rotationally support inside the container, at a predetermined height with respect to the base wall, a centrifuge drum for removing liquid from a cleaning head and, on a second side opposite to the first side, at the protruding portion on the first side, a hollow portion shaped so as to be combined with the protruding portion.

### CROSS-REFERENCE TO RELATED APPLICATIONS

This application claims the benefit of Italian Utility Model Application No. MI2011U000331, filed Oct. 18, 2011, which is hereby incorporated by reference in its entirety.

### FIELD

This technology generally relates to containers for removing liquid from a cleaning head.

### BACKGROUND

As referred to herein, “cleaning head” indicates an operating portion of a cleaning device, which includes cleaning elements, such as lint, cloths or the like, suitable to absorb and release in a controlled manner liquids, in particular water and/or detergents, to perform cleaning operations.

Currently, during cleaning operations carried out by means of cleaning heads of this kind, the dirty liquid must be removed periodically therefrom. For this purpose, containers equipped with suitable seats are used, usually in the form of a drum suitable to receive the cleaning head and to allow removing therefrom the liquid by applying pressure or by centrifugation. The removed liquid collects at the bottom of the container.

Containers for removing liquid from cleaning heads operating by centrifugation are emerging increasingly due to the greater effectiveness in removing the liquid and the least effort required by the operator for this operation. Such containers generally include a centrifuge drum suitable to receive the cleaning head, which can be set rotationally in such a way as to subject the cleaning head into centrifugation. The centrifuge drum can be placed in rotation by drive means, associated with the container thereof, or through external drive means, for example through the cleaning device thereof to which the cleaning head is associated. This second drive method allows making containers for removing of liquid from cleaning heads that have a simple structure, reduced weight, and particularly limited production costs, and are therefore suitable for a large-scale marketing for domestic use.

Typically, in the containers of the type described above for removing of liquid from a cleaning head of the centrifuge drum is rotationally supported within the container by means of at least one element or support portion that extends for a certain height within the container from a base wall thereof. The presence of a portion that extends substantially from the base wall of the container within the container thereof hinders stacking in a compact manner of multiple containers of the above type on one another. This has a negative impact on the logistics of the product and its related costs particularly when larger volumes are involved for transport and/or storing in a warehouse.

### SUMMARY

In one aspect, the present invention provides a container for removing liquid from a cleaning head through centrifugation of the type described above having an improved structure that makes stacking possible in a compact manner of multiple containers on one another.

More specifically, an exemplary container of the present invention includes a base wall and a lateral wall peripherally extending from a first side of the base wall, wherein the base wall includes on the first side, a protruding portion adapted to rotationally support in the container, at a predetermined height with respect to the base wall, a centrifuge drum for removing liquid from a cleaning head. The base wall further includes, on a second side opposite to the first side, at the protruding portion on the first side, a hollow portion shaped so as to be combined with that of the said protruding portion.

In exemplary containers of the present invention, the base wall can be advantageously configured in such a way so that to a protruding portion, provided on the inner side thereof to support the centrifuge drum, corresponds on the outer side to a hollow portion shaped so as to be combined with that protruding portion. With this structure, the presence of an element or support portion for a centrifuge drum within the container does not present a hindrance for stacking of a second container of the same type, since this element or support portion, here represented by the aforementioned protruding portion, can be received in the correspondent hollow portion present on the outer side of the base wall of the second container.

Accordingly, exemplary containers in accordance with the present invention can therefore be stacked on one another in a relatively compact and substantially similar manner to that obtainable with containers having flat base walls. Thereby overall dimensions during transport and the warehouse space required to store an increased number of containers can be reduced resulting in efficiencies in logistics as well as reduced transportation and storage costs. Moreover, the manufacture of exemplary containers in accordance with the present invention does not result in any reduced functional efficiency or product weight or increased production costs as compared to known containers of similar type for removing of liquid from a cleaning head.

### BRIEF DESCRIPTION OF THE DRAWINGS

FIG. 1 is a schematic perspective view from above of an exemplary container;

FIG. 2 is a schematic sectional view of an exemplary container;

FIG. 3 is a schematic perspective view from above of an exemplary container with a centrifuge drum mounted in an operating position;

FIG. 4 is a schematic perspective view from above of an exemplary container with a centrifuge drum arranged on the base of the container in a non-operating position adapted to allow stacking of another container;

FIG. 5 is a schematic sectional view of two exemplary containers in a stacked position; and

FIG. 6 is a schematic sectional view of two exemplary containers including respective centrifuge drums in a stacked position.

### DETAILED DESCRIPTION

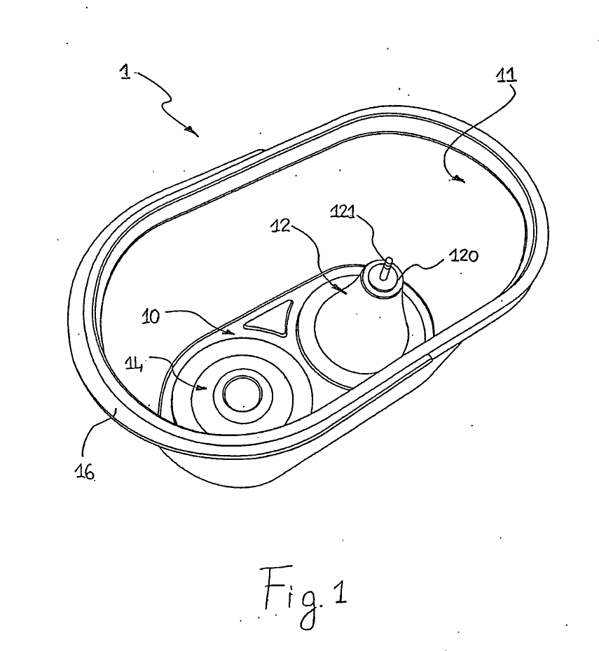

Referring to FIGS. 1-6 an exemplary container 1 for removing liquid from a cleaning head in accordance with the present invention and generally configured in this example as a bucket is shown. The cleaning head (not shown) for example, may be part of a mop or other similar cleaning device. Generally, the cleaning head includes cleaning elements, such as for example, a plurality of lint or one or more cloths, in a material able to absorb and release in a controlled manner, such liquids as water and/or detergents to perform cleaning operations.

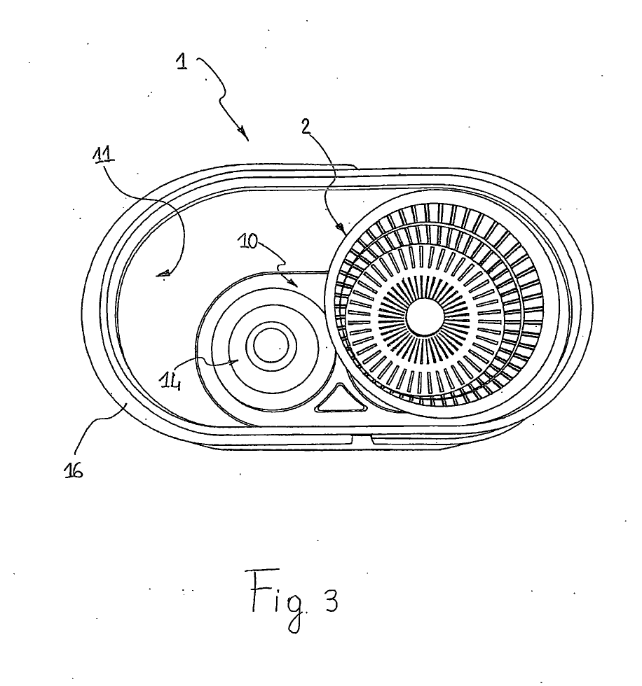

The container 1 includes a base wall 10 and a lateral wall 11 peripherally extending from a first side, within the container, of the base wall 10. The base wall 10 includes, on this inner first side, a protruding portion 12 adapted to rotationally support in the container 1, at a predetermined height with respect to the base wall 10, a centrifuge drum 2 for removing liquid from a cleaning head. The centrifuge drum 2, shown particularly in FIGS. 3-4 and 6, has a conventional structure and is associated in a removable manner to the container 1 at the above-mentioned protruding portion 12.

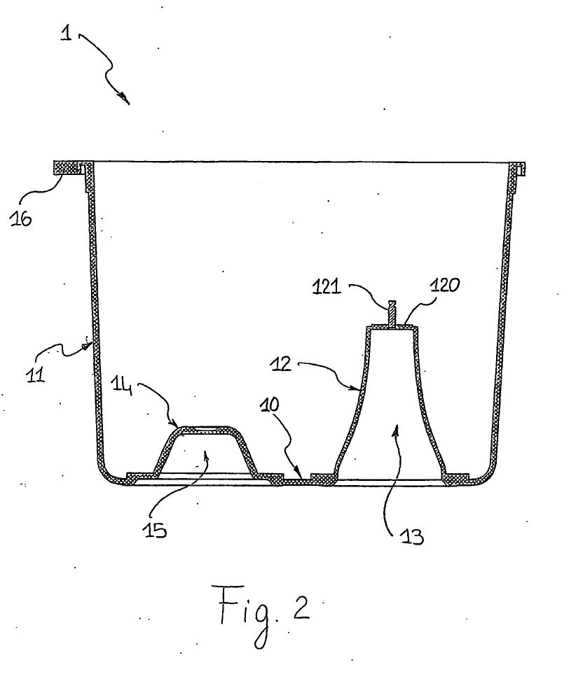

Referring specifically to FIG. 2, in this example, the base wall 10 of the container 1 includes on a second side opposite said first side, external to the container 1, at the protruding portion 12 on the inner side, a hollow portion 13 shaped so as to be combined with that of the protruding portion 12.

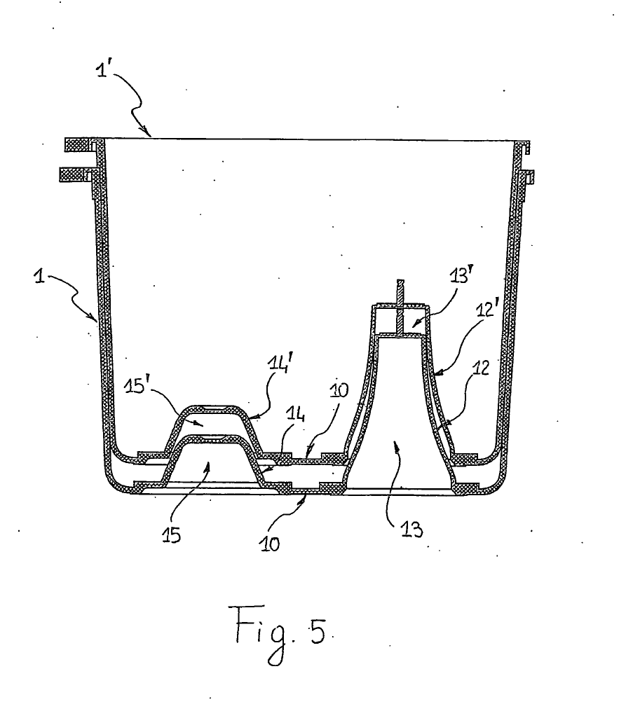

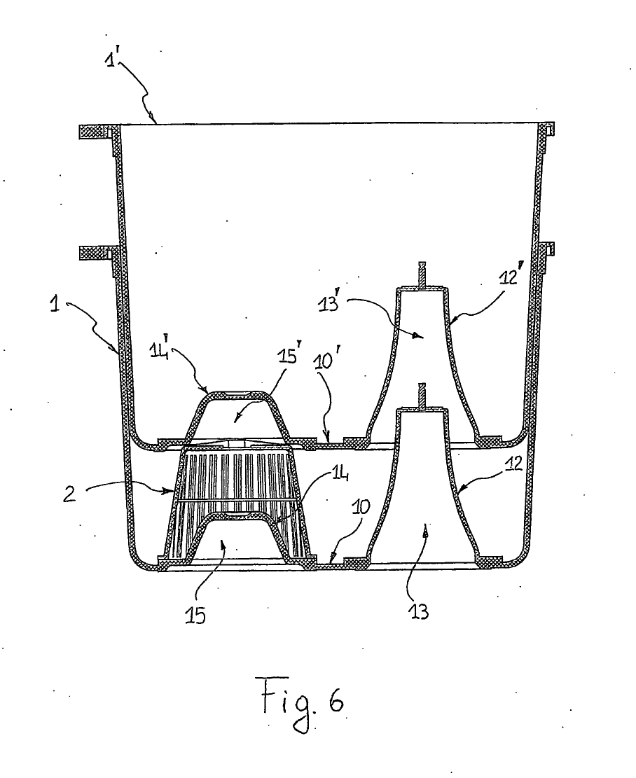

As particularly evident with reference to FIGS. 5-6 and described in more detail below, this particular exemplary configuration of the base wall 10 allows stacking multiple containers 1 on one another in a compact manner, as the protruding portion 12 present on the inner side of the base wall 10 of a first container 1 can be substantially received by a corresponding hollow portion 13 on the outer side of the base wall 10 of a second container 1 disposed above, without creating any obstacle to stacking.

In one example, the protruding portion 12 can have a rotationally symmetrical cross section. In other examples, the protruding portion 12 has a cross section that tapers away from the base wall 10. Such configuration advantageously allows the protruding portion the necessary resistance and structural stability with a minimum space within the container 1. Moreover, the absence of sharp edges and the tapered shape facilitate the advantages through moulding.

Referring specifically to FIGS. 1-2, the protruding portion 12 can include, at a free end thereof, opposite to the base wall 10 of the container 1 a flat surface portion 120, substantially parallel to the base wall 10. The presence of the flat surface portion 120 provides a stable and flat support for the centrifuge drum 2.

Still referring to the free end, opposite to the base wall 10, the protruding portion 12 can include coupling means 121 for rotationally coupling the centrifuge drum 2. In the examples shown in FIGS. 1-6, the coupling means 121 includes a connecting pin, which can be associated in a fixed manner or be removable with respect to the protruding portion 12 and extends substantially perpendicularly to the flat surface portion 120, along the symmetry axis of the protruding portion 12.

The height of the protruding portion 12 with respect to the base wall 10 can be selected based on the height of the centrifuge drum 2, so that this latter element is supported into position as high as possible with respect to the base wall 10 without protruding with respect to the free edge of the lateral wall 11. In some examples, the height of the protruding portion 12 is at least equal to about half the height of the lateral wall 11.

Referring to FIG. 3, an exemplary container 1 with a centrifuge drum 2 is shown. The centrifuge drum 2 can be mounted in an operating position, or supported, rotationally free, by the protruding portion 12 of the base wall 10.

In some examples, the base wall 10 of the container 1 includes on the inner side a further protruding portion or stud 14. Optionally, the base wall 10 includes on its outer side a further hollow portion 15 at the stud 14 on the inner side, shaped so as to be combined with the shape of the latter, in a similar manner as described and illustrated with reference to the hollow portion 13 at the protruding portion 12 for supporting the centrifuge drum 2.

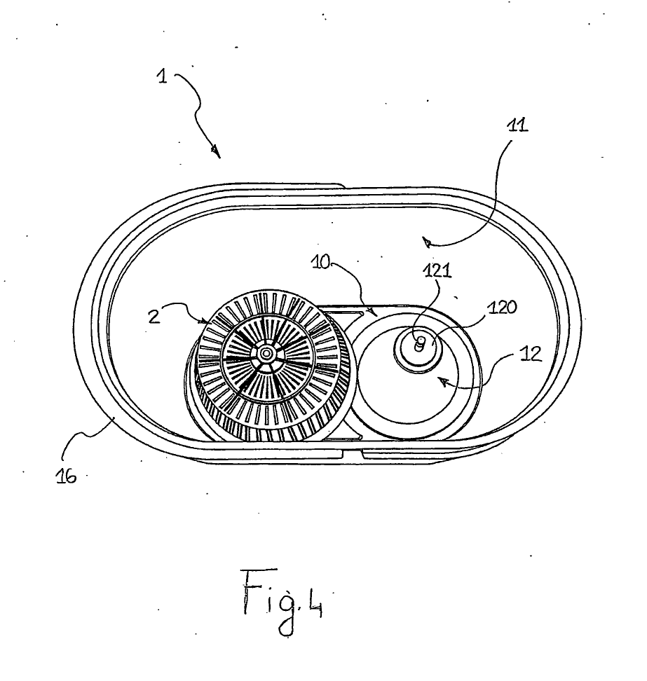

The stud 14 can serve to prevent the centrifuge drum 2 from moving freely when it is removed from the protruding portion 12 of the support and placed on the base wall 10 of the container 1 as shown in FIGS. 4 and 6, particularly in view of stacking multiple containers 1. The shape and the peripheral dimensions of the stud 14 at the base wall 10 of the container 1 can be selected in such a way as to correspond to the shape and dimensions of the mouth of the centrifuge drum 2, and optionally also to allow for a coupling therewith with a minimal interference.

The container 1 can be made of plastic material, optionally in one piece by injection moulding. The stud 14 and the corresponding hollow portion 15 are moreover useful for easy extraction of the base wall 10 of the container 1 from a mould. Additionally, in some examples, the container 1 comprises a handle 16 for easy lifting and carrying.

Referring to FIG. 5 two exemplary containers 1, 1′ for removing liquid from a cleaning head are shown stacked on one other. In this examples, the protruding portion 12 for the support of the centrifuge drum 2 and (if present) the stud 14 on the inner side of the base wall of the bottom container 1 may be received respectively in the hollow portions 13′ and 15′ present on the outer side of the bottom wall 10′ of the container 1′ standing above, without preventing a compact stacking of the containers 1, 1′.

Referring to FIG. 5 an alternative method of stacking exemplary containers 1, 1′ for removing of liquid from a cleaning head is shown wherein the stacked containers 1, 1′ also include the respective centrifuge drums 2 (for the sake of simplicity, FIG. 6 shows only the centrifuge drum 2 of the bottom container 1). As described and illustrated earlier, each centrifuge drum 2 is positioned within the respective container 1, 1′ placed upside down on the base wall 10, 10′ at stud 14, 14′. This method of stacking, although less compact than that shown in FIG. 5, allows carrying and/or storing in a warehouse containers 1 equipped with a plurality of accessories necessary for use, and therefore directly ready for marketing.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A container for removing liquid from a cleaning head, comprising:
a base wall and a lateral wall peripherally extending from a first side of the base wall, the base wall further comprising:
on the first side, a protruding portion adapted to rotationally support inside the container, at a predetermined height with respect to the base wall, a centrifuge drum for removing liquid from a cleaning head; and
on a second side opposite to the first side, at the protruding portion on the first side, a hollow portion shaped so as to be combined with the protruding portion.

2. The container as set forth in claim 1, wherein the protruding portion has a rotationally symmetrical profile.

3. The container as set forth in claim 1, wherein the protruding portion has a profile which tapers as it extends away from the base wall.

4. The container as set forth in claim 1, wherein the protruding portion further comprises, at a free end thereof opposite to the base wall, a flat surface portion which is substantially parallel to the base wall.

5. The container as set forth in claim 1, wherein the protruding portion further comprises, at a free end thereof opposite to the base wall, coupling means for rotationally coupling the centrifuge drum.

6. The container as set forth in claim 1, wherein the protruding portion has a height from the base wall equal to at least about half the height of the lateral wall.

7. The container as set forth in claim 1, wherein the container comprises one piece made by injection moulding.

8. A method for making a container, comprising injection moulding in one piece:
a base wall and a lateral wall peripherally extending from a first side of the base wall, the base wall further comprising:
on the first side, a protruding portion adapted to rotationally support inside the container, at a predetermined height with respect to the base wall, a centrifuge drum for removing liquid from a cleaning head; and
on a second side opposite to the first side, at the protruding portion on the first side, a hollow portion shaped so as to be combined with the protruding portion.

9. The method as set forth in claim 8, wherein the protruding portion has a rotationally symmetrical profile.

10. The method as set forth in claim 8, wherein the protruding portion has a profile which tapers as it extends away from the base wall.

11. The method as set forth in claim 8, wherein the protruding portion further comprises, at a free end thereof opposite to the base wall, a flat surface portion which is substantially parallel to the base wall.

12. The method as set forth in claim 8, wherein the protruding portion further comprises, at a free end thereof opposite to the base wall, coupling means for rotationally coupling the centrifuge drum.

13. The method as set forth in claim 8, wherein the protruding portion has a height from the base wall equal to at least about half the height of the lateral wall.
